(19) United States
(12) Patent Application Publication
(10) Pub. No.: US 2026/0316621 A1
(43) Pub. Date: Oct. 15, 2026

(54) APPARATUS AND METHOD FOR CONTROLLING REPLACEMENT OF ROBOT BATTERIES FOR OPERATING MULTIPLE ROBOTS

(71) Applicants: HYUNDAI MOTOR COMPANY, Seoul (KR); Kia Corporation, Seoul (KR); SUNGSHIN WOMEN’S UNIVERSITY R&DB FOUNDATION, Seoul (KR)

(72) Inventors: Won Hee KIM, Hwaseong-si (KR); Jaehoon YOU, Hwaseong-si (KR); Ji Min HONG, Hwaseong-si (KR); Soomin SHIM, Hwaseong-si (KR); Seong Wook HWANG, Seoul (KR); Joon Young KIM, Seoul (KR); Namgyo KIM, Chuncheon-si (KR); Young Eun KIM, Bucheon-si (KR); Bo Kyung KIM, Daejeon (KR); Gyeongbin RYOO, Seoul (KR); Jeong Min OH, Seoul (KR); Ji Soo KANG, Seoul (KR)

(21) Appl. No.: 19/405,331

(22) Filed: Dec. 1, 2025

(30) Foreign Application Priority Data
Apr. 10, 2025 (KR) 10-2025-0046561

(51) Int. Cl. B60L 53/80; B60L 53/36; B60L 53/62; B60L 53/66; B60L 53/68; G05D 1/661

(52) U.S. Cl. CPC B60L 53/80; B60L 53/36; B60L 53/62; B60L 53/66; B60L 53/68; G05D 1/661; B60L 2240/70

(57) ABSTRACT

An apparatus and method for controlling replacement of robot batteries by determining a replacement schedule of second batteries of robots by using first batteries charged in a battery replacement station. The replacement schedule is determined based on a state-of-charge (SOC) of each of the first batteries and the second batteries communicated through a transceiver, a plurality of battery performance information pieces from a battery performance database transmitted through the transceiver, and a plurality of route information pieces by which each robot reaches the battery replacement station from a work location. The replacement schedule includes battery replacement timings of one or more robots, where a battery replacement command is transmitted to the one or more robots through the transceiver.

### CROSS-REFERENCE TO RELATED APPLICATION

This application claims priority to and the benefit of Korean Patent Application No. 10-2025-0046561, filed with the Korean Intellectual Property Office, on Apr. 10, 2025, the entire contents of which are incorporated herein by reference.

### TECHNICAL FIELD

The present disclosure relates to an apparatus and method for controlling replacement of robot batteries for operating multiple robots. More particularly, the present disclosure relates to an apparatus and method for controlling replacement of robot batteries to more efficiently perform a plurality of robot battery replacement works by establishing a battery replacement schedule determined based on state-of-charges (SOC) of a plurality of robot batteries, replacement station batteries, or the like.

### BACKGROUND

When operating multiple robots, a continuous operation environment without service interruption issues may be provided by efficiently designing the replacement timing of robot batteries. In some cases, the replacement system for multiple robot batteries may have limitations in efficiently determining the replacement timing between multiple robots.

In some cases, the efficient operation of multiple robots may be difficult without newly assigning works to ensure smooth subsequent works after each robot performs battery replacement works.

### SUMMARY

The present disclosure describes an apparatus and method for controlling replacement of robot batteries capable of continuously operating a plurality of robots without an operation delay at maximum, and preventing the battery performance degradation due to battery charging and discharging, by rapidly determining a replacement schedule between a plurality of robot batteries and replacement station batteries by using battery performance, lifespan information, or the like stored in a battery performance database (DB).

According to one aspect of the subject matter described in this application, an apparatus is configured to control replacement of robot batteries including (i) a plurality of first batteries disposed at a battery replacement station for charging and (ii) a plurality of second batteries provided to a plurality of robots. The apparatus is configured to determine a replacement schedule for the plurality of second batteries by using the plurality of first batteries charged at the battery replacement station. The apparatus includes a transceiver, a processor, and a memory storing a program configured to, based on being executed by the processor, cause the apparatus to perform operations. The operations include receiving a state-of-charge (SOC) of each of the plurality of second batteries from each of the plurality of robots through the transceiver, based on determining that one or more second batteries among the received SOCs of the plurality of second batteries are less than or equal to a predetermined first threshold value, performing a battery replacement work, receiving an SOC of each of the plurality of first batteries from the battery replacement station through the transceiver, receiving a plurality of battery performance information pieces of the plurality of first batteries and the plurality of second batteries from a battery performance database through the transceiver, generating each of a plurality of route information pieces, each of the plurality of route information pieces being configured to guide a corresponding one of the plurality of robots to reach the battery replacement station from a work location, performing a battery replacement operation by using (i) the SOC of each of the plurality of first batteries, (ii) the SOC of each of the plurality of second batteries, (iii) the plurality of battery performance information pieces, and (iv) the plurality of route information pieces, determining battery replacement timings of one or more first robots among the plurality of robots, and transmitting a battery replacement command to at least one of the one or more first robots through the transceiver.

Implementations according to this aspect can include one or more of the following features. For example, performing the battery replacement operation can include: generating a first list representing a replacement priority of the battery replacement station based on (i) the SOC of each of the plurality of first batteries and (ii) the plurality of battery performance information pieces, the first list including the plurality of first batteries; generating a second list representing replacement priorities of the plurality of robots based on (i) the SOC of each of the plurality of second batteries, (ii) the plurality of battery performance information pieces, and (iii) the plurality of route information pieces, the second list including the plurality of second batteries; obtaining a first value by adding a number of batteries of the first batteries in the first list for which charge finishing points are calculated; obtaining a second value by adding all of a number of the plurality of second batteries in the second list; calculating a third value that is a smaller value among the first value and the second value; generating a third list by extracting items from each of the first list and the second list according to a number of the third value; and performing a one-to-one matching between the first batteries in the first list and the second batteries in the second list.

In some implementations, determining the battery replacement timings can include determining each of the battery replacement timings that is a time point at which a robot corresponding to one item in the third list returns to the battery replacement station after completing a current work. In some examples, performing the battery replacement operation further can include calculating a charging speed and a discharging speed of each of the plurality of first batteries and the plurality of second batteries based on the plurality of battery performance information pieces.

In some implementations, the charging speed can define a charge capacity per unit time of each of the plurality of first batteries, where generating the first list can include: based on at least one of the plurality of first batteries having a current SOC value greater than or equal to a second threshold value, determining the charge finishing points by adding a current time to a charging duration of each of the plurality of first batteries, wherein the charging duration is determined by dividing, by the charging speed of each of the plurality of first batteries, a difference between a current SOC value of each of the plurality of first batteries and a second threshold value; and based on each of the charge finishing points of the plurality of first batteries being calculated, determining the first list by listing each of the plurality of first batteries in an order from an earliest charge finishing point among the charge finishing points.

In some implementations, generating the second list can include: determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station; and based on the first value being greater than or equal to the second value, generating the second list by listing the plurality of second batteries in an ascending order from a lowest final SOC among the final SOCs of the plurality of second batteries.

In some implementations, generating the second list can include: determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station; based on the first value being less than the second value, determining a remaining plurality of second batteries by excluding, in an ascending order from a lowest final SOC among the final SOCs of the plurality of second batteries, a number of second batteries among the plurality of second batteries corresponding to a difference between the first value and the second value; and generating the second list by listing the remaining plurality of second batteries in the ascending order from the lowest final SOC.

In some implementations, the operations can further include: receiving a pending work list from a work database through the transceiver, the pending work list including work items; determining whether at least one work item among the work items is performable before the battery replacement timing of a first robot among the plurality of robots; and based on determining that the at least one work item is performable before the battery replacement timing, transmitting a command to the first robot through the transceiver to perform the at least one work item.

In some implementations, the operations can further include: based on transmitting the battery replacement command to the one or more first robots through the transceiver, generating a list of the one or more first robots in a descending order from a highest SOC at the battery replacement timings; assigning a work item among a pending work list with a highest battery consumption amount to the one or more first robots in the descending order from the highest SOC; and transmitting, through the transceiver, a command to the one or more first robots to perform the work item after a corresponding one of the battery replacement timings.

In some implementations, the operations can further include: transmitting a standby command to remaining one or more second robots excluding the one or more first robots from the plurality of robots through the transceiver; determining whether an SOC of each of the one or more second robots is less than or equal to a threshold reference value; determining one or more third robots having the SOC less than or equal to the threshold reference value among the one or more second robots; transmitting, to the one or more third robots through the transceiver, a command to enter an energy-saving state after completing a current work of each of the one or more third robots; and transmitting information regarding the one or more third robots to a user notification system through the transceiver.

According to another aspect, a method is performed for controlling replacement of robot batteries including (i) a plurality of first batteries disposed at a battery replacement station for charging and (ii) a plurality of second batteries provided to a plurality of robots. The method is performed to determine a replacement schedule for the plurality of second batteries by using the plurality of first batteries charged at the battery replacement station. The method includes: receiving a state-of-charge (SOC) of each of the plurality of second batteries from each of the plurality of robots through a transceiver; based on determining that one or more second batteries among the received SOCs of the plurality of second batteries are less than or equal to a predetermined first threshold value, initiating a battery replacement work; receiving an SOC of each of the plurality of first batteries from the battery replacement station through the transceiver; receiving a plurality of battery performance information pieces of the plurality of first batteries and the plurality of second batteries from a battery performance database through the transceiver; generating each of a plurality of route information pieces, each of the plurality of route information pieces being configured to guide a corresponding one of the plurality of robots to reach the battery replacement station from a work location; performing a battery replacement operation by using (i) the SOC of each of the plurality of first batteries, (ii) the SOC of each of the plurality of second batteries, (iii) the plurality of battery performance information pieces, and (iv) the plurality of route information pieces; determining battery replacement timings of one or more first robots among the plurality of robots; and transmitting a battery replacement command to at least one of the one or more first robots through the transceiver.

Implementations according to this aspect can include one or more of the following features. For example, performing the battery replacement operation can include: generating a first list representing a replacement priority of the battery replacement station based on (i) the SOC of each of the plurality of first batteries and (ii) the plurality of battery performance information pieces, the first list including the plurality of first batteries; generating a second list representing replacement priorities of the plurality of robots based on (i) the SOC of each of the plurality of second batteries, (ii) the plurality of battery performance information pieces, and (iii) the plurality of route information pieces, the second list including the plurality of second batteries; obtaining a first value by adding a number of batteries of the first batteries in the first list for which charge finishing points are calculated; obtaining a second value by adding all of a number of the plurality of second batteries in the second list; calculating a third value that is a smaller value among the first value and the second value; generating a third list by extracting items from each of the first list and the second list according to a number of the third value; and performing a one-to-one matching between the first batteries in the first list and the second batteries in the second list.

In some implementations, determining the battery replacement timings can include determining each of the battery replacement timings that is a time point at which a robot corresponding to one item in the third list returns to the battery replacement station after completing a current work. In some examples, performing the battery replacement operation further can include calculating a charging speed and a discharging speed of each of the plurality of first batteries and the plurality of second batteries based on the plurality of battery performance information pieces.

In some implementations, the charging speed can define a charge capacity per unit time of each of the plurality of first batteries, where generating the first list can include: based on at least one of the plurality of first batteries having a current SOC value greater than or equal to a second threshold value, determining the charge finishing points by adding a current time to a charging duration of each of the plurality of first batteries, wherein the charging duration is determined by dividing, by the charging speed of each of the plurality of first batteries, a difference between a current SOC value of each of the plurality of first batteries and a second threshold value; and based on each of the charge finishing points of the plurality of first batteries being calculated, determining the first list by listing each of the plurality of first batteries in an order from an earliest charge finishing point among the charge finishing points.

In some implementations, generating the second list can include: determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station; and based on the first value being greater than or equal to the second value, generating the second list by listing the plurality of second batteries in an ascending order from a lowest final SOC among the final SOCs of the plurality of second batteries.

In some implementations, generating the second list can include: determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station; based on the first value being less than the second value, determining a remaining plurality of second batteries by excluding, in an ascending order from a lowest final SOC among the final SOCs of the plurality of second batteries, a number of second batteries among the plurality of second batteries corresponding to a difference between the first value and the second value; and generating the second list by listing the remaining plurality of second batteries in the ascending order from the lowest final SOC.

In some implementations, the method can further include: receiving a pending work list from a work database through the transceiver, the pending work list including work items; determining whether at least one work item among the work items is performable before the battery replacement timing of a first robot among the plurality of robots; and based on determining that the at least one work item is performable before the battery replacement timing, transmitting a command to the first robot through the transceiver to perform the at least one work item.

In some implementations, the method can further include: based on transmitting the battery replacement command to the one or more first robots through the transceiver, generating a list of the one or more first robots in a descending order from a highest SOC at the battery replacement timings; assigning a work item among a pending work list with a highest battery consumption amount to the one or more first robots in the descending order from the highest SOC; and transmitting, through the transceiver, a command to the one or more first robots to perform the work item after a corresponding one of the battery replacement timings.

In some implementations, the method can further include: transmitting a standby command to remaining one or more second robots excluding the one or more first robots from the plurality of robots through the transceiver; determining whether an SOC of each of the one or more second robots is less than or equal to a threshold reference value; determining one or more third robots having the SOC less than or equal to the threshold reference value among the one or more second robots; transmitting, to the one or more third robots through the transceiver, a command to enter an energy-saving state after completing a current work of each of the one or more third robots; and transmitting information regarding the one or more third robots to a user notification system through the transceiver.

In some implementations, when replacing batteries of a plurality of robots, simultaneously operable robots can be secured as many as possible by establishing an optimized replacement schedule by using battery performance information, or the like, work delay can be prevented by appropriately distributing works before and after the replacement, and even when exceptional situations occur, such as spare batteries not being charges, the plurality of robots can be efficiently operated by establishing an appropriate replacement schedule.

In some implementations, in the case of charging and using multiple batteries, by monitoring and operating batteries to charge and use them within a certain range of SOC, they can be managed to decrease of lifespan and performance of batteries.

### BRIEF DESCRIPTION OF THE DRAWINGS

FIG. 1 schematically illustrates an example of a system for controlling replacement of robot batteries.

FIG. 2 is a schematic view showing an example interaction of an apparatus for controlling replacement of robot batteries, a battery replacement station, and a plurality of robots.

FIG. 3 to FIG. 6 are flowcharts showing an example of a robot battery replacement method and a method of assigning works before and after the replacement.

FIG. 7 shows an example of a method of determining replacement priorities among batteries within a battery replacement station.

FIG. 8 shows an example of a method of determining replacement priorities among batteries mounted on a plurality of operating robots.

FIG. 9 shows an example of a method of matching a robot battery replacement priority list and a station battery replacement priority list.

FIG. 10 shows an example of a method of matching a battery replacement priority list in an error occurrence situation.

FIG. 11A and FIG. 11B show an example communication flow of a robot battery replacement scenario in a chronological order.

FIG. 12 sequentially shows an example of a robot battery replacement scenario.

FIG. 13 sequentially shows an example of a robot battery replacement scenario in one situation.

FIG. 14A and FIG. 14B sequentially show an example of a robot battery replacement scenario in another situation.

### DETAILED DESCRIPTION

One or more implementations of the disclosure will be described more fully hereinafter with reference to the accompanying drawings such that a person skill in the art can easily implement the implementations. As those skilled in the art would realize, the described implementations can be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, the terms “unit”, “part” or “portion”, “-er”, and “module” in the specification refer to a unit that processes at least one function or operation, which can be implemented by hardware, software, or a combination of hardware and software.

Hereinafter, implementations of the present disclosure will be described with reference to the drawings.

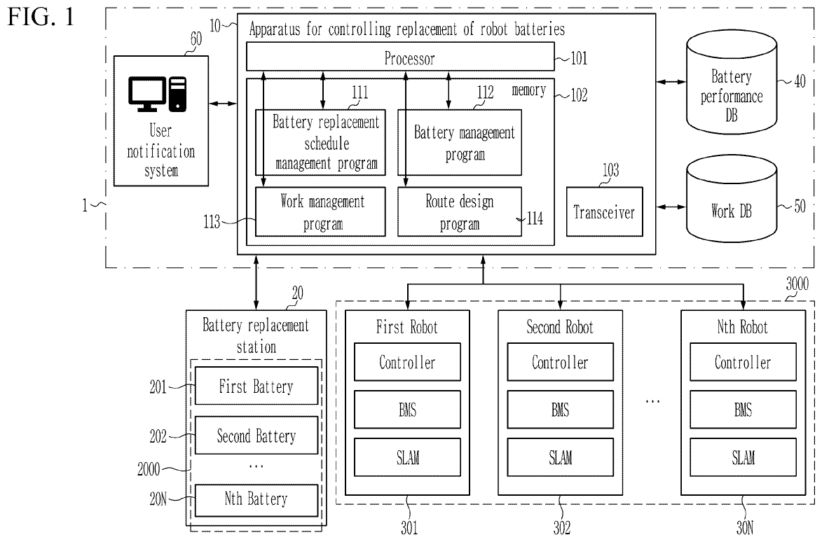

FIG. 1 schematically shows an example of a system 1 for controlling replacement of robot batteries and interaction between a battery replacement station 20 and a plurality of robots 3000.

According to FIG. 1, the system 1 for controlling replacement of robot batteries can include a robot an apparatus 10 for controlling replacement of batteries, a battery performance database 40, a work database 50, and a user notification system 60.

The apparatus 10 for controlling replacement of robot batteries can control battery replacement with respect to each of the plurality of robots 3000 by using the battery replacement station 20.

The apparatus 10 for controlling replacement of robot batteries can determine battery replacement priorities of a plurality of currently operating robots 3000 and a plurality of batteries 2000 of the battery replacement station 20, can establish a replacement schedule thereof, and after establishing the replacement schedule, can assign works to be performed to be performed by the robot before and after the battery replacement timing.

The apparatus 10 for controlling replacement of robot batteries can include a processor 101, a memory 102 and a transceiver 103.

The memory 102 can store a battery replacement schedule management program 111, a battery management program 112, a work management program 113 and a route design program 114.

The processor 101 can receive SOC, performance information, route information, or the like, with respect to a plurality of batteries requiring the battery replacement control through the transceiver 103 by executing programs stored in the memory 102, and can perform a battery replacement operation for determining the battery replacement timing by using a plurality of received information pieces. In addition, the processor 101 can control the transceiver 103 to transmit a battery replacement necessity notification of the robot to the user, to transmit a manual replacement inducing notification to the user notification system 60. The user can receive the manual replacement inducing notification through the user notification system 60, and can replace an inoperable battery with another battery by himself.

The processor 101 can communicate with the battery performance database 40 and the work database 50 through the transceiver 103, and can receive and transmit information for the

### Battery Replacement Control.

In more detail, the battery replacement schedule management program 111 can determine the time point for performing battery swapping between respective batteries installed on the plurality of operating robots 3000 and spare batteries of the battery replacement station 20. In addition, the battery management program 112 can periodically monitor the state-of-charge (SOC) of all batteries mounted on the battery replacement station 20 and the plurality of robots 3000, and by transmitting/receiving information with the battery performance database 40 through the transceiver 103, performance information such as lifespan of respective batteries can be updated and a battery replacement cycle can be determined. The work management program 113 can update a pending work list that is to be performed currently by transmitting/receiving information with the work database 50 through the transceiver 103. The work management program 113 can generate a command to perform a specific work of the pending work list before and after the battery replacement timing of battery replacement-scheduled robot and transmit it through the transceiver 103. The route design program 114 can be configured to perform an operation of designing a route for each in the plurality of robots 3000 to drive to the battery replacement station.

In some implementations, the battery replacement station 20 can include the plurality of batteries 2000, and each battery can be disposed in each area such as a replacement area and a charging station of the battery replacement station 20. The plurality of batteries 2000 can include a first battery, a second battery, and an Nth battery (hereinafter, N is a natural number).

In some implementations, the plurality of robots 3000 can be configured of a controller configured to control work-performing and driving of the robot, a battery management system (BMS) configured to monitor a battery state, and simultaneous localization and mapping (SLAM) for confirming location information of the robot. The plurality of robots 3000 can include a first robot, a second robot, and an Nth robot.

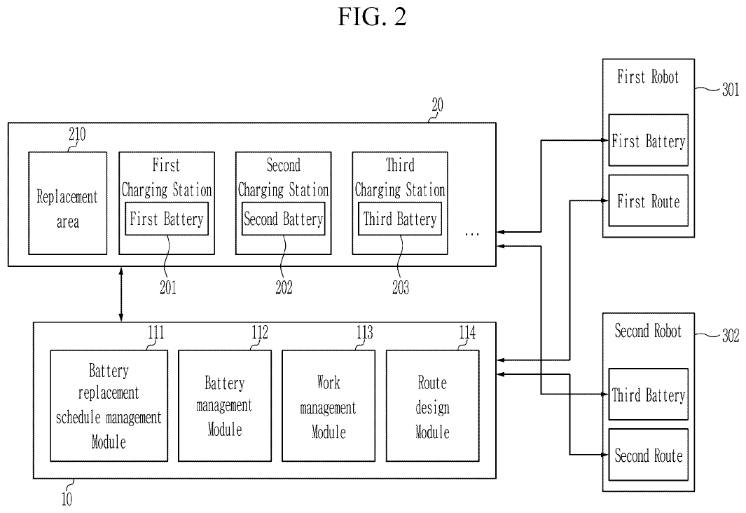

FIG. 2 is a schematic view showing an example of interaction of an apparatus for controlling replacement of robot batteries, a battery replacement station, and a plurality of robots.

FIG. 2 shows in detail operations of the apparatus 10 for controlling replacement of robot batteries interacting with the battery replacement station 20, a first robot 301, and a second robot 302. Specifically, the processor 101 can determine a replacement-scheduled battery for each of the first robot 301 and the second robot 302 by using information obtained from the battery management program 112, the work management program 113, the route design program 114 by executing the battery replacement schedule management program 111, and then transmit information on the determined replacement-scheduled battery to the battery replacement station 20.

The processor 101 can determine a replacement-scheduled first battery 201 with respect to the first robot 301 and transmit it to the battery replacement station 20 and the first robot 301, and can determine a replacement-scheduled third battery 203 with respect to the second robot 302 and transmit it to the battery replacement station 20 and the second robot 302.

In addition, the processor 101 can determine a driving route (hereinafter, a first route) for the first robot 301 to move to the battery replacement station 20 and transmit it to the first robot 301, and the processor 101 can determine a driving route (hereinafter, a second route) for the second robot 302 to move to the battery replacement station 20 and transmit it to the second robot 302.

For example, the processor 101 can determine the replacement-scheduled third battery 203 and the second route with respect to the second robot 302, can transmit information regarding the third battery 203 and the second route to the second robot 302, and can transmit a replacement scheduling command of the third battery 203 with respect to the second robot 302 to the battery replacement station 20. The battery replacement station 20 can move the replacement-scheduled third battery 203 to a replacement area 210 in advance. The second robot 302 can move along the second route to reach the battery replacement station 20.

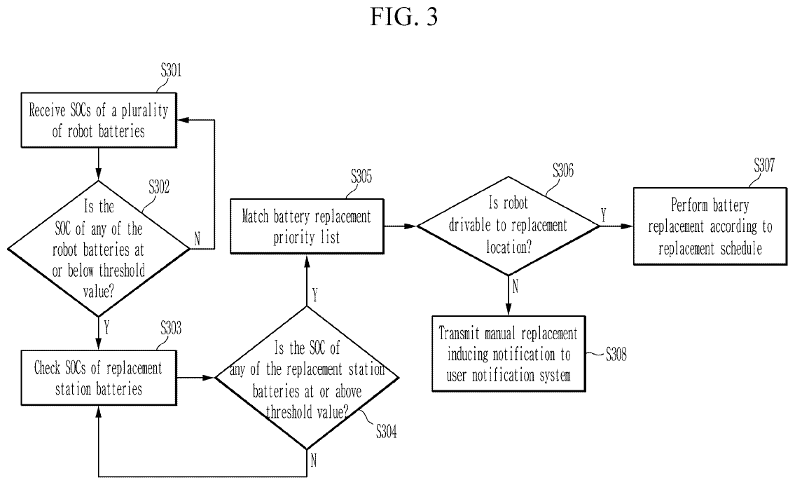

FIG. 3 to FIG. 6 are flowcharts for explaining an example of a robot battery replacement method and a method of assigning works before and after the replacement.

FIG. 3 is a flowchart sequentially showing an example of the process for the processor 101 to replace the robot batteries by executing programs stored in the memory 102.

At step S301, the processor 101 can periodically monitor SOCs of a plurality of robot batteries by executing the battery management program 112. In this case, at step S302, the processor 101 can check whether a battery having an SOC of a predetermined first threshold value or lower exists among the plurality of robot batteries. In some examples, the first threshold value can be 20%. When a battery satisfying the condition of this step does not exist, the processor 101 can return to the step S301, to monitor the SOC of the plurality of robot batteries again. When the condition of the step S302 is satisfied, it can proceed to step S303, the processor 101 can request and receive the SOC of each of the plurality of batteries 2000 existing in a charging or standby state in the battery replacement station 20 from the battery replacement station 20.

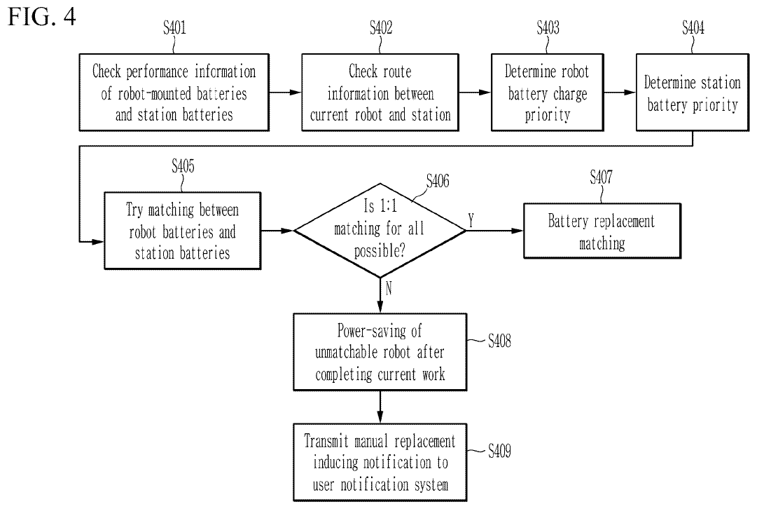

At step S304, the processor 101 can determine whether there exists a battery having an SOC of a predetermined second threshold value or more among the plurality of batteries 2000 of the battery replacement station 20 by executing the battery management program 112. Whether a battery having an SOC of the second threshold value or more exists among the plurality of batteries 2000 can be one of trigger conditions of a battery replacement work (hereinafter, a first condition). When the first condition is satisfied, the processor 101 can execute the battery replacement schedule management program 111, to perform an operation of generating a battery replacement priority list with respect to each of the plurality of batteries 2000 and the plurality of robots 3000 and then matching them according to priorities, at step S305. In some examples, detailed steps of the step S305 will be described later in more detail with reference to FIG. 4.

When the first condition is not satisfied, the processor 101 can determine that there is not a replaceable spare battery in the battery replacement station 20. Then, the process can return to the step S303 after a preset time without performing the battery replacement, and the processor 101 can request again the SOCs of the plurality of batteries 2000 to the battery replacement station 20.

In addition, by proceeding to a subsequent step S306, the processor 101 can determine whether the replacement-scheduled robots currently has SOC drivable to the battery replacement station 20, based on the battery replacement timing and driving route of the replacement-scheduled robots determined at the step S305 by executing the battery replacement schedule management program 111. When a certain robot is drivable to the battery replacement station 20, the processor 101 transmits the replacement timing scheduled for the corresponding robot, a designated driving route, and replacement-scheduled battery information, together with the command instructing the corresponding robot to move to the battery replacement station 20, at step S307. In some examples, when an SOC of a specific robot is determined to be insufficient to drive to the battery replacement station 20 at the step S306, it can proceed to a step S308, so that the processor 101 can transmit the manual replacement inducing notification to the user notification system through the transceiver 103. Accordingly, even when an automatic replacement by the system is not possible because the current battery SoC of the corresponding robot is not sufficient (i.e., less than a threshold), by requesting manual replacement to the user, management can be performed so that a problem may not occur in the operation of the plurality of robots.

FIG. 4 is a flowchart for explaining in detail an example of a step S305 among battery replacement steps of FIG. 3.

At the step S304 of FIG. 3, when the first condition is satisfied, at step S401, the processor 101 can receive performance information of the plurality of batteries 2000 and batteries installed on the plurality of robots 3000 from the battery performance database 40. For example, battery performance information can be state-of-health (SoH) representing battery lifespan.

When rechargeable batteries such as lithium-ion batteries are frequently used to a completely charged or completely discharged state, performance degradation and lifespan decrease can occur. In addition, this can stress the chemical structure inside the battery, which can cause problems such as capacity reduction and internal resistance increase. Accordingly, by establishing a replacement schedule so that each battery SOC can circulate within a predetermined critical range by using battery performance information received at the step S401, the present disclosure can optimize the performance of batteries being used to be maintained for a long time. For example, according to the present disclosure, a critical range of 20%-85% can be preset with respect to the SOC of the batteries being used in the system, and the apparatus 10 for controlling replacement of robot batteries can be controlled to replace batteries in a timely manner without going beyond the corresponding critical range.

In some examples, the processor 101 can calculate an actual time to be charged to a target SOC for each time and an actual time of operation available compared to a current SOC of each battery by using the received battery performance information.

At step S402, the processor 101 can generate the route information according to which each of the plurality of robots 3000 moves the battery replacement station 20 by executing the route design program 114. The processor 101 can receive location information through the transceiver 103 by using the SLAM of each of the plurality of robots 3000, to generate the route information based on the received location information.

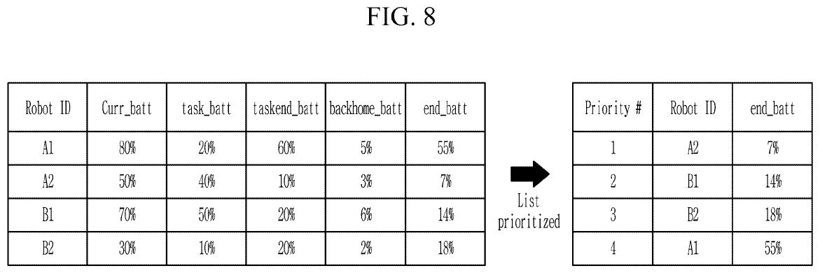

At step S403, the processor 101 can generate a priority list representing the battery replacement priorities of the plurality of robots 3000 (hereinafter, a second list) by executing the battery replacement schedule management program 111. The priority determining method will be described in detail with reference to FIG. 8 below.

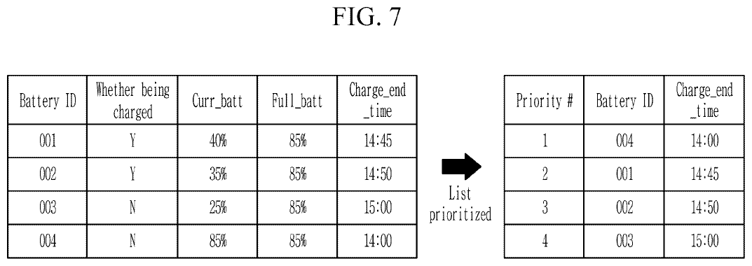

Subsequently, at step S404, the processor 101 can generate a priority list representing the replacement priorities of the plurality of batteries 2000 of the battery replacement station 20 (hereinafter, a first list) by executing the battery replacement schedule management program 111. The priority determining method will be described in detail with reference to FIG. 7 below.

Based on the first and second lists generated at the step S403 and the step S404, at step S405, the processor 101 can perform the operation of matching each item of the first list one-to-one with each item of the second list by executing the battery replacement schedule management program 111. In some examples, the processor 101 can calculate a value obtained by adding the number of batteries among the plurality of batteries 2000 of the first list for which the charge finishing point is calculated (hereinafter, a first value), and a value obtained by adding the numbers of batteries of the plurality of robots 3000 of the second list (hereinafter, a second value).

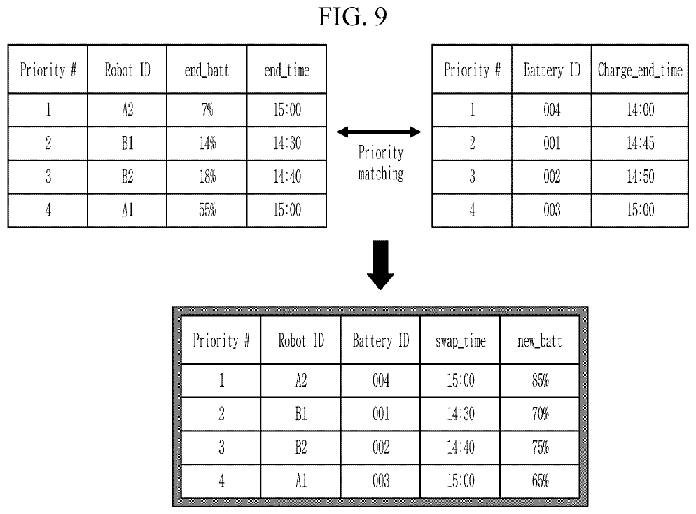

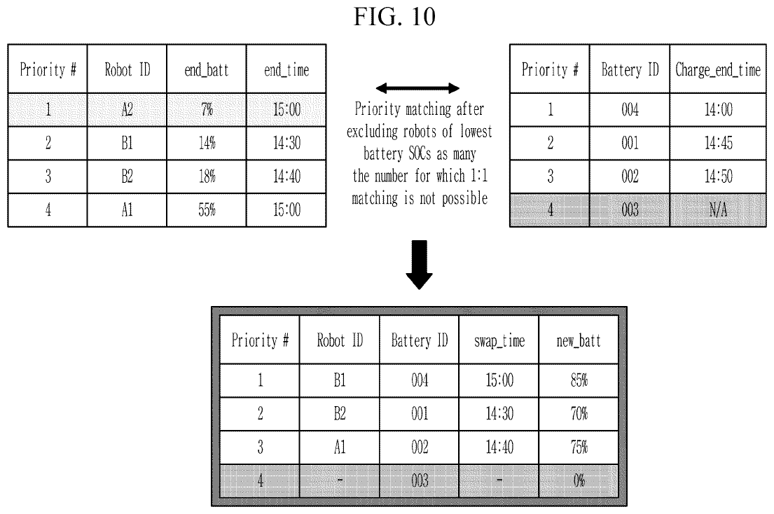

Subsequently, at step S406, the processor 101 can determine whether the first value and the second value are the same, and when one-to-one matching is possible because they are the same, can proceed to step S407, and can extract items of the first list and the second list in the order of priority and match them one-to-one with each other. The corresponding step will be later described in further detail with reference to FIG. 9 and FIG. 10.

In some examples, when the first value and the second value are not the same, the processor 101 can proceed to step S408, and can extract items of the first list and the second list in the order of priority and match them one-to-one with each other as many as a smaller value among the first value and the second value (hereinafter, a third value).

In addition, at the step S408, the processor 101 can determine whether there exists a robot among the robots for which battery replacement matching has failed, whose battery SOC has fallen below a predetermined third threshold value to have difficulty in continuous operation, and when there exists, can transmit a command to enter a power saving mode after completing the work that is currently performed to the corresponding robot. Thereafter, at step S409, the processor 101 can transmit the manual replacement inducing notification to the user notification system 60 through the transceiver 103 so that the user can manually replace the battery with respect to the robot having entered the power saving mode.

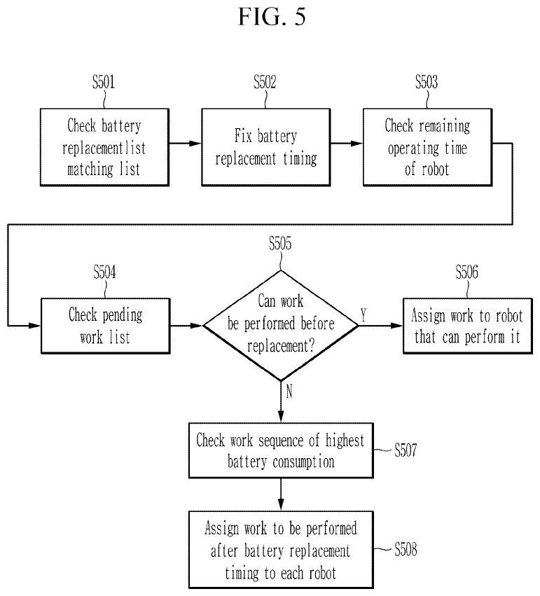

FIG. 5 shows an example of a subsequent work assigning step of the robots for which battery replacement is determined at the step S307 of FIG. 3. At step S501, the processor 101 can check by a battery replacement matching list executing the battery replacement schedule management program 111, and afterwards, when the battery replacement timing of each of the plurality of robots 3000 is fixed at step S502, can check a remaining operable time of each robot by executing the battery management program 112 at step S503. Since each of the plurality of robots 3000 can perform a work that can be performed among the pending work list by using a remaining time before the confirmed battery replacement timing, when a remaining operable time of each robot is checked and then a work that can be performed is assigned, the efficiency of the robot operation system can be significantly improved. Therefore, at step S504, the processor 101 can execute the work management program 113 to receive the pending work list from the work database 50, to check whether there exist works scheduled to be performed. Afterwards, at step S505, the processor 101 can check whether there exists a work that can be performed before the battery replacement timing by each of the plurality of robots 3000 based on battery SOCs of the plurality of robots 3000, the battery replacement timing, and the pending work list. For example, with respect to a certain battery replacement-scheduled robot 1, the processor 101 can determine whether to perform the work based on data such as a remaining time before battery replacement of the robot 1 and a current SOC of the robot 1, a battery consumption amount for the robot 1 to reach the battery replacement station 20, and a battery consumption amount for a corresponding work. When a work that can be performed exists, at step S506, the processor 101 can assign corresponding works to the corresponding robot and transmit a command to perform it.

When the processor 101 has determined that there is not a work that can be performed among the pending work list before battery replacement by all the replacement-scheduled robots at the step S505, the processor 101 can proceed to step S507, to check a work sequence with highest battery consumption amount among works of the pending work list. At step S508, the processor 101 can execute the work management program 113 to list works in the above sequence, and can re-assign the listed works to the robots for which battery replacement has been completed in a sequence of highest SOCs. Then, works with highest battery consumption can be assigned to robots of highest SOCs, so that the probability of the assigned tasks being performed continuously without battery replacement during the process increases, thereby increasing the entire efficiency of the robot operation system.

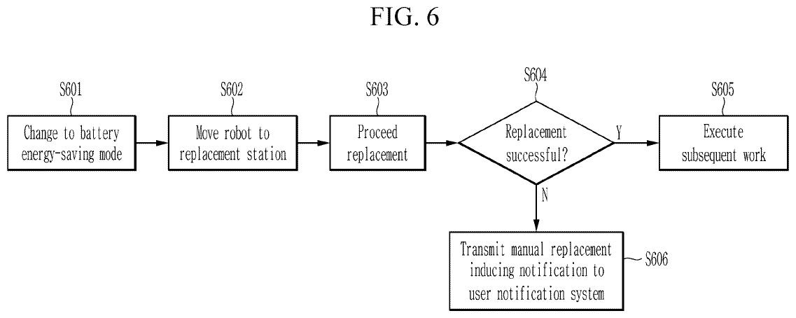

FIG. 6 shows in further detail an example of a step in which the battery is actually replaced after the step S307 of FIG. 3.

When the battery replacement schedule is established, the processor 101 can transmit a command to change a corresponding replacement-target robot into a power saving mode to the corresponding robot at step S601 before the actual battery replacement work by executing the battery management program 112. Subsequently, at step S602, the processor 101 can transmit a command to move the corresponding replacement-target robot to the battery replacement station 20 to the corresponding robot. At step S603, the processor 101 can transmit a command for enabling the battery of the replacement-target robot and the replacement-target battery of station matched by executing the battery replacement schedule management program 111 to be exchanged with each other to the battery replacement station 20. Afterwards, at step S604, the processor 101 can receive information on whether the battery replacement was successful from the battery replacement station 20, and when it was successful, it can proceed to step S605, to transmit a command to immediately execute a subsequent work re-assigned by using the work management program 113 as described above with reference to FIG. 5 to the corresponding robot. When a result notifying that the battery replacement has failed on the reason such as a mechanical defect or a control operation error of the battery replacement station 20 is received from the battery replacement station 20 at the step S604, the processor 101 can proceed to step S606, and can transmit a notification for inducing manual replacement to the user notification system 60 through the transceiver 103.

FIG. 7 shows in detail an example of a method of determining replacement priorities among batteries of a battery replacement station.

The processor 101 can perform the battery replacement operation by executing the battery replacement schedule management program 111, and particularly, can perform an operation of determining the replacement priorities of batteries in charge or standby in the battery replacement station 20, to generating the replacement priority list based on this. Referring to FIG. 7, in order to explain the present disclosure, as a simple example, a method of determining replacement priorities of four batteries is represented in a table. The table can indicate ID corresponding to each battery and whether each battery is being charged. In addition, for each battery, Curr_batt representing the current SOC of the battery, Full_batt representing a maximum SOC threshold value at which level battery performance can be maintained, and Charge_end_time value representing a charge finishing point charged to Full_batt can be indicated. A station battery replacement priority list is first created when it is confirmed that one or more of Curr_batt values of a plurality of batteries has a value greater than or equal to the second threshold value, which is a predetermined maximum threshold value Full_batt (when the first condition is satisfied). In this case, they have priorities in the order of earliest charge finishing points of station batteries, and the station battery replacement priority list listed according to the priorities can be found in the table in the right of the arrow in FIG. 7. Charge_end_time of the replacement priority list of the station batteries can be calculated as a value obtained by dividing a value obtained by subtracting Curr_batt from Full_batt value by a charging speed of each of the batteries, and then adding a current time. The charging speed of each of the batteries can be confirmed from the battery performance information received from the above-described battery performance database 40, and the charging speed of each of the batteries represents the charge capacity per unit time of each of the batteries.

FIG. 8 shows in detail an example of a method of determining replacement priorities among batteries mounted on a plurality of operating robots.

The processor 101 can perform the battery replacement operation by executing the battery replacement schedule management program 111, and particularly, can perform an operation of determining the replacement priorities of batteries mounted on the plurality of robots 3000, to generating a robot battery replacement priority list based on this.

FIG. 8 illustrates an example of a table representing IDs identifying each of the robots, curr_batt representing a current battery SOC of the corresponding robot, task_batt referring to a battery consumption amount to perform the currently assigned work, taskend_batt referring to a battery SOC at the time of completing the current work, backhome_batt referring to a battery consumption amount for corresponding robot to return to the battery replacement station 20, and end_batt referring to a value obtained by subtracting both task_batt and backhome_batt values from curr_batt. In the left of the arrow table, the process of calculating an end_batt value representing the battery SOC of each of corresponding robots expected when having returned to the battery replacement station 20 after completing the currently assigned work is shown, and in the right of the arrow table, the robot battery replacement priority list listed in the order of smallest end_batt values can be found.

FIG. 9 shows in detail an example of a method of matching the robot battery replacement priority list and the station battery replacement priority list.

Referring to FIG. 9, an end_batt item and an end_time item of the robot battery replacement priority list determined in FIG. 7 and FIG. 8 can be confirmed. The processor 101 can calculate the end_time item by executing the battery replacement schedule management program 111, the work management program 113, and the route design program 114, and the end_time item can be calculated as a value obtained by adding the time for completing the current work of each robot from the current time and the time for moving from the current location of the robot to the station. In addition, in the table in the right, a Charge_end_time item of the station battery replacement priority list can be found, and here, whether the Charge_end_time items corresponding to respective station batteries respectively have values can be confirmed. As will be described later with reference to FIG. 10, an error can occur in which a discharge battery among batteries in charging or standby at the battery replacement station 20 is not charged due to a certain technical problem, and in this case, the processor 101 cannot calculate the Charge_end_time item value of that battery station battery, and an invalid value that does not have a specific value such as N/A can be input.

In some examples, when an error does not occur as in FIG. 9, the end_batt item of the robot battery replacement priority list and the Charge_end_time items of the station battery replacement priority list can all have certain valid values. In addition, in each list, the number of batteries for which the end_batt item is valid value and the number of batteries for which the Charge_end_time item is a valid value are the same as 4, and a replacement priority matching list can be generated by one-to-one matching the lists that are already aligned according to priorities.

That is, a priority 1 item can be matched with a robot ID A2-battery ID 004, a priority 2 item can be matched with a robot ID B1-battery ID 001, and one-to-one matching for the remaining priorities can be made in the same way. Swap_time of the replacement priority matching list can be determined to be the same as end_time of each corresponding robot of the robot battery replacement priority list, and new_batt can be determined as the SOC at the replacement timing of the replacement-scheduled station battery. In other words, since the replacement-scheduled station battery is maintained to be charged until the replacement timing, and the SOC of the replacement-scheduled station battery at the time of the replacement timing can be represented as new_batt. As an example, the priority 1 item of the replacement priority matching list of FIG. 9 can be the robot ID A2-battery ID 004, and swap_time is inserted to be the same as 15:00, which is end_time of the robot A2, and new_batt value can be inserted as the SOC value of the battery ID 004 when swap_time, which is the battery replacement timing, is 15:00. In other words, since Charge_end_time of the battery ID 004 is completed at 14:00, which is earlier than 15:00, new_batt value of the battery ID 004 is already charged enough to the target value at 15:00 and indicated by 85%, which is the Full_batt value.

FIG. 10 shows in detail an example of a method of matching the battery replacement priority list in an error occurrence situation.

In some examples, not only when an error does not occur as in FIG. 9, but also in an error situation where there exists a battery that is not charged due to an unexpected situation occurring at the battery replacement station 20 as in FIG. 10, the battery replacement schedule can be appropriately designed thereby providing a method that can efficiently operate the entire robot operation system.

In the table in the right of FIG. 10, the priority list of the batteries currently existing in the battery replacement station 20 can be checked, and when there is an item for which Charge_end_time is not calculated, it can be arranged at the lowest priority according to the above-described priority determining method. Here, a battery of a battery ID 003 having the last priority is indicated as N/A since Charge_end_time is not calculated due to a certain external environment or technical problem. At this time, although the number of items of the robot battery replacement priority list in the left is 4, the number of batteries for which charge finishing points, i.e., Charge_end_time, of the station battery replacement priority list in the right are calculated is 3, which is smaller by one than the total number of robot batteries in the left table. Accordingly, one-to-one matching is not performed, and in this case, when the battery replacement schedule is established according to the method described above in FIG. 9, it is not efficient to maintain operating robots in as many number as possible. Accordingly, when one-to-one matching is not possible, manual replacement can be induced for the robot of smallest end_batt value, and batteries of only the robots as many as the number of remaining replaceable station batteries can be automatically replaced, which is advantageous in the efficiency of the entire operation system.

Therefore, when Charge_end_time of the battery ID 003 is not calculated and indicated as N/A as in the situation of FIG. 10, the priority determining method of the robot battery replacement priority list is different from the method of FIG. 9. Specifically, for convenience, when a value obtained by adding the number of batteries among the station batteries for which the charge finishing point is calculated is defined as the first value, and a value obtained by adding all of the numbers of the plurality of robot batteries is defined as the second value, when the first value is smaller than the second value, that is, when the number of replaceable batteries among the station batteries is not sufficient for the one-to-one matching, robot batteries are excluded from the priority list as many as a number obtained by subtracting the first value from the second value in order of lowest final SOCs. Thereafter, the remaining robot batteries are listed in order of lowest final SOCs, to generate a new robot battery replacement priority, and then one-to-one matching with the station battery replacement priority list can be performed. An as an example, it can be seen that a lowermost table in FIG. 10 shows a result obtained as the ID A2 robot having the lowest end_batt value in the robot battery replacement priority list as many as matched number 1 is excluded, remainders are arranged in order of lowest final SOCs, and one-to-one matching with the station battery replacement priority list is performed.

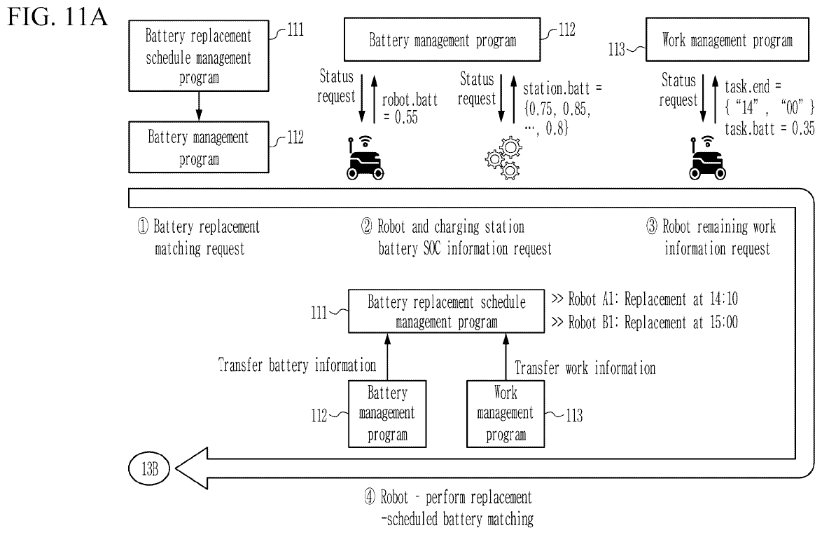

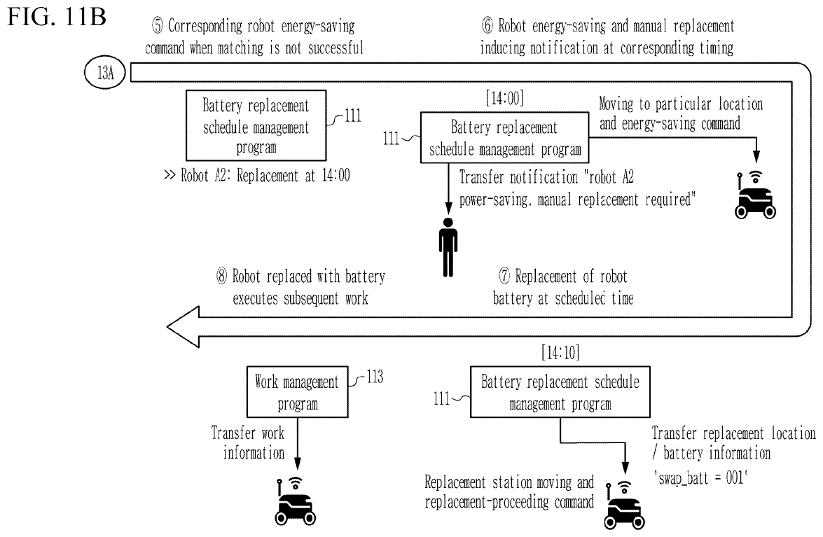

FIG. 11A and FIG. 11B show an example of a communication flow of a robot battery replacement scenario in chronological order.

As shown in FIG. 11, through a plurality of programs performed by the processor 101, the entire operation for the apparatus 10 for controlling replacement of batteries to control battery replacement with respect to the plurality of robots and assign works can be performed. The plurality of programs can include the battery replacement schedule management program 111, the battery management program 112, the work management program 113 and the route design program 114, and can be stored in an internal memory 102. The processor 101 can input and/or output data and/or commands between programs while executing the plurality of programs.

The battery management program 112 can periodically monitor the SOC of the robot battery, and when the condition is met, can transmit the result to the battery replacement schedule management program 111. Subsequently, the battery replacement schedule management program 111 can transmit a request to initiate a process for battery replacement matching to the battery management program 112, and upon receiving a command, the battery management program 112 can transmit a command to request the SOC values of the plurality of robots 3000 and the plurality of batteries 2000 of the station. Each robot and station having received the corresponding command can transmit the SOC value of batteries to the apparatus 10 for controlling replacement of batteries by using each communication interface, and the processor 101 can receive data through the transceiver 103 and set and store it as an input to the battery management program 112.

Afterwards, when the apparatus 10 for controlling replacement of batteries requests transmission of work state to each of the robots by executing the work management program 113, each of the robots can transmit a work finishing time point and a battery consumption amount information when performing the work to the apparatus 10 for controlling replacement of batteries, and the apparatus 10 for controlling replacement of batteries can receive it and set and store it as an input in the work management program 113. The battery replacement schedule management program 111 can match the battery replacement timing and replacement-target battery of each of the robots by using the previously received battery information and work information, to establish the schedule. When there exists a robot that has failed in matching, by executing the battery replacement schedule management program 111, the apparatus 10 for controlling replacement of batteries can transmit an energy-saving command to the corresponding robot. As such, the robot having received the energy-saving command can move to the designated location and enter and wait in an energy-saving state, and transmit the manual replacement inducing notification to the user notification system 60 by using the battery replacement schedule management program 111 to induce the user to manually replace the battery of the power-saving robot. For a robot for which battery replacement is scheduled according to a predetermined replacement schedule, the processor 101 can transmit the time to move to replacement station and information on replacement-target battery to each corresponding robot through the transceiver 103 by executing the battery replacement schedule management program 111. When the battery replacement is completed, the processor 101 can transmit a command to a corresponding robot to perform a preset subsequent work by executing the work management program 113, so that each robot can appropriately perform a subsequent work without delay.

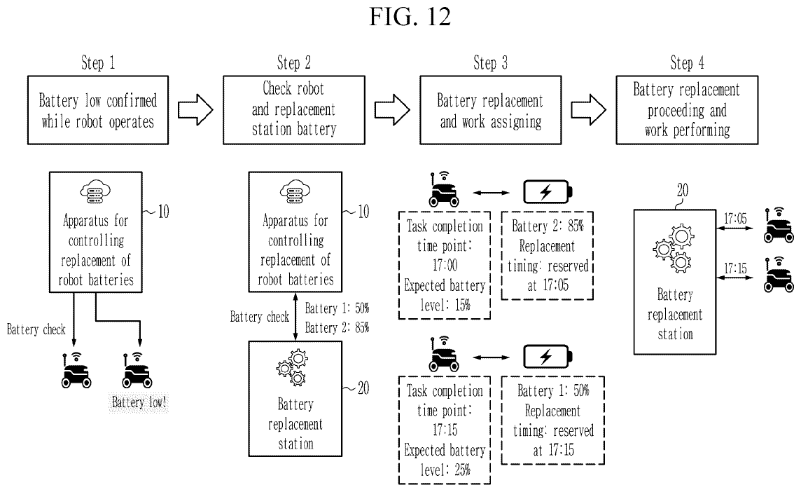

FIG. 12 sequentially shows an example of a robot battery replacement scenario.

FIG. 12 to FIG. 14A and FIG. 14B briefly shows the process in which implementations of the present disclosure for replacement of a plurality of robot batteries are actually performed, in various situations. As described above, while the plurality of robots 3000 are operated, the apparatus 10 for controlling replacement of robot batteries can monitor whether a battery SOC of at least one robot decreases below the predetermined first threshold value. This can be performed as the control apparatus 10 request each of the plurality of robots 3000 to periodically transmit the current battery SOC, and each of the robots transmits the corresponding information to the apparatus 10 for controlling replacement of robot batteries. At a subsequent step, when a case occurs in which the battery SOC of at least one robot falls to be below the first threshold value, the apparatus 10 for controlling replacement of robot batteries can check information of the batteries of the plurality of robots 3000 and the plurality of batteries 2000 of the battery replacement station 20, and can check whether one or more batteries having an SOC of the specific second threshold value exist among the batteries of the replacement station. When the mentioned condition is satisfied, the control apparatus 10 can fix the battery replacement timing by performing the battery replacement operation and then matching replacement-target batteries. When the battery replacement schedule is established, the battery replacement-scheduled robots can complete the current work and additional works that can be performed until the replacement timing and then move to the battery replacement station 20 at the replacement-scheduled time, to replace the currently mounted battery with a charged battery, to immediately perform works newly assigned from the apparatus 10 for controlling replacement of robot batteries, without delay.

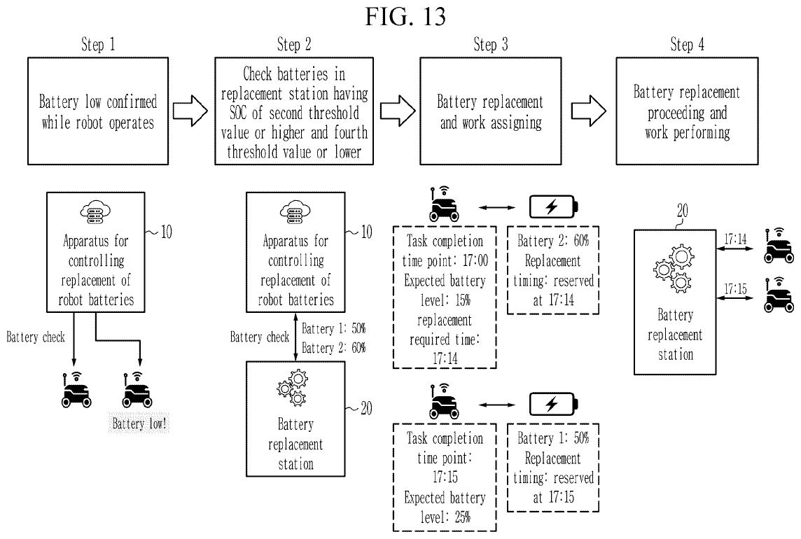

FIG. 13 sequentially shows an example of a robot battery replacement scenario in one situation. In some cases, the situation can be an exceptional situation.

For example, unlike the scenario of FIG. 12, the battery replacement scenario of FIG. 13 illustrates the process of performing the battery replacement work, even when there is not any a battery having the SOC of the specific second threshold value or greater among the batteries of the replacement station. In the battery replacement process, it is preferable to replace the robot battery when there is a battery charged to the specific second threshold value level exists among the batteries of the battery replacement station 20, so that the plurality of robots can be smoothly operated, but the battery replacement cycle can be managed to be shorter so that the battery replacement process can be managed to operate even in exceptional situations as in FIG. 13. When the above example is implemented, since the user can manually replace the battery in exceptional situations, the inconvenience caused by the delay of operation of the entire system can be prevented, and since consumption of resources such as assigning additional man-power can be reduced, implementation of an organic robot operation system can be enabled.

Referring back to FIG. 13, during the operation process of the plurality of robots 3000, the apparatus 10 for controlling replacement of robot batteries can periodically monitor whether the battery SOC of at least one robot falls below the predetermined first threshold value, and when the corresponding trigger is satisfied, at a subsequent step, whether there is at least one battery having an SOC of the specific second threshold value or more among the batteries of the replacement station is checked. In the scenario of FIG. 13, even if there exists no battery having an SOC of the specific second threshold value or more, the step of checking whether there exists one or more batteries having an SOC of a fourth threshold value, which is lower than the second threshold value, or greater, can be further included. In other words, when the battery SOC of any one among the plurality of batteries 2000 of the battery replacement station 20 is the fourth threshold value or higher and the second threshold value or lower satisfy, the battery replacement operation can be performed and the battery replacement schedule can be established. In some examples, the second threshold value can be 85%, and the fourth threshold value can be 60%. Thereafter, the plurality of robots 3000 can receive a command from the control apparatus 10 and move to the battery replacement station 20 to actually perform the battery replacement work with respect to the matched batteries, and can perform the assigned work without delay after battery replacement. That scenario can further improve the robot operation efficiency in situations where the battery replacement cycle is to be maintained to be shorter according to the type and characteristic of the work performed by the robot.

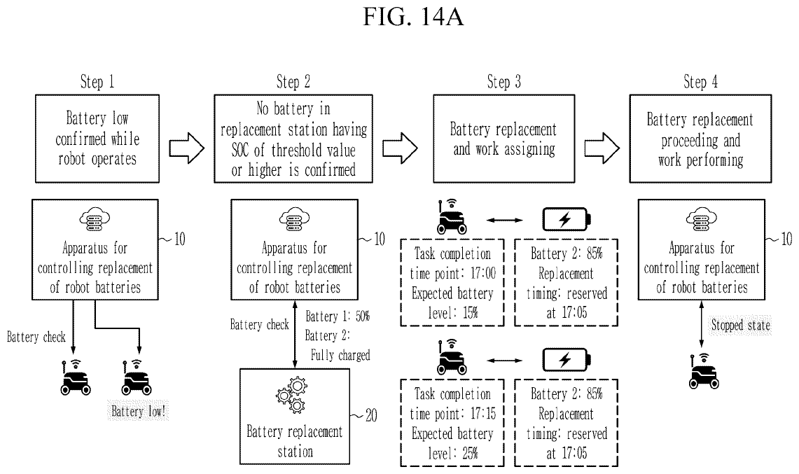

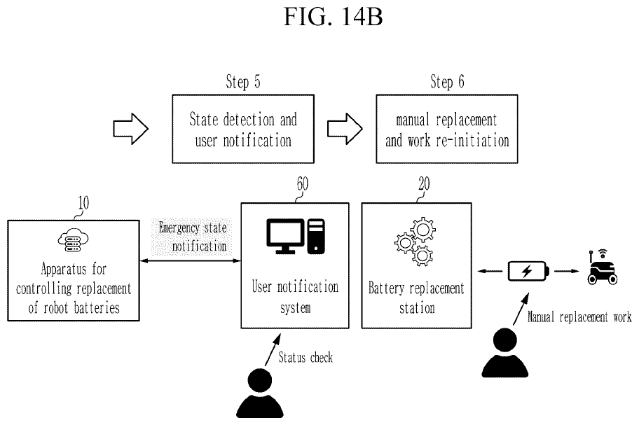

FIG. 14A and FIG. 14B sequentially show an example of a robot battery replacement scenario in another exceptional situation.

The last scenario of FIG. 14A and FIG. 14B briefly explains the interaction between the apparatus 10 for controlling replacement of robot batteries and the plurality of robots 3000, in a situation where the step S606 of FIG. 6 described above is performed.

As described above with reference to FIG. 12, each operation can be performed in the same process as the step 3 of FIG. 12 until a step 3 of FIG. 14A. Afterwards, when a failure occurs during battery replacement or the replacement-target robot stops due to an unexpected technical error or external environment problem, the apparatus 10 for controlling replacement of robot batteries can check whether signals of the replacement-target robot are normally received. When a situation occurs in which a response is not received even upon requesting a failure notification or a specific signal from the replacement-target robot, the apparatus 10 for controlling replacement of robot batteries can determine that a failure has occurred in the replacement-target robot, and can transmit a notification indicating that an emergency situation has occurred to the user notification system 60. After the user checking the content of the notification of the notification system 60, the user can perform a subsequent operation such as manual replacement, to cope with the failure situation.

A method can be implemented through a computing device.

The computing device can include at least one of a processor, a memory, a user interface input device, a user interface output device, and storage device that communicate through a bus. The computing device can also include a network interface electrically connected a network. The network interface can transmit or receive signals with other entities through a network. The network interface can be a transceiver that can transmit or receive wired/wireless signals carrying information and/or data, signals, messages, or the like.

The processor can be implemented in various types such as a micro controller unit (MCU), an application processor (AP), a central processing unit (CPU), a graphics processing unit (GPU), a neural processing unit (NPU), or the like, and can be any type of semiconductor device capable of executing instructions stored in the memory or storage device. The processor can be configured to implement the functions and methods described above.

The memory and the storage device can include various types of volatile or non-volatile storage media. For example, the memory can include a read-only memory (ROM) and random-access memory (RAM). In some implementations, the memory can be located inside or outside the processor, and the memory can be connected to the processor through various known means.

At least some configurations or functions can be implemented as a program or software executable in the computing device, and the program or software can be stored in a computer-readable medium.

At least some configurations or functions can be implemented by using hardware or circuitry of the computing device, or can be implemented as separate hardware or circuitry that can be electrically connected to the computing device.

Since the implementations described above are specific implementations for realizing the present disclosure, it should be understood that the present disclosure includes not only the above-described implementations but also implementations that can be simply designed or easily changed by using the above-described implementations. Therefore, the spirit of the present disclosure should not be limited to the implementations described above, and should be defined by the following claims of the present disclosure and their equivalents.

What is claimed is:

1. An apparatus for controlling replacement of robot batteries, the robot batteries including (i) a plurality of first batteries disposed at a battery replacement station for charging and (ii) a plurality of second batteries provided to a plurality of robots, the apparatus being configured to determine a replacement schedule for the plurality of second batteries by using the plurality of first batteries charged at the battery replacement station, the apparatus comprising:
a transceiver;
a processor; and
a memory storing a program configured to, based on being executed by the processor, cause the apparatus to perform operations comprising:
receiving a state-of-charge (SOC) of each of the plurality of second batteries from each of the plurality of robots through the transceiver,
based on determining that one or more second batteries among the received SOCs of the plurality of second batteries are less than or equal to a predetermined first threshold value, performing a battery replacement work,
receiving an SOC of each of the plurality of first batteries from the battery replacement station through the transceiver,
receiving a plurality of battery performance information pieces of the plurality of first batteries and the plurality of second batteries from a battery performance database through the transceiver,
generating each of a plurality of route information pieces, each of the plurality of route information pieces being configured to guide a corresponding one of the plurality of robots to reach the battery replacement station from a work location,
performing a battery replacement operation by using (i) the SOC of each of the plurality of first batteries, (ii) the SOC of each of the plurality of second batteries, (iii) the plurality of battery performance information pieces, and (iv) the plurality of route information pieces,
determining battery replacement timings of one or more first robots among the plurality of robots, and
transmitting a battery replacement command to at least one of the one or more first robots through the transceiver.

2. The apparatus of claim 1, wherein performing the battery replacement operation comprises:
generating a first list representing a replacement priority of the battery replacement station based on (i) the SOC of each of the plurality of first batteries and (ii) the plurality of battery performance information pieces, the first list including the plurality of first batteries;
generating a second list representing replacement priorities of the plurality of robots based on (i) the SOC of each of the plurality of second batteries, (ii) the plurality of battery performance information pieces, and (iii) the plurality of route information pieces, the second list including the plurality of second batteries;
obtaining a first value by adding a number of batteries of the first batteries in the first list for which charge finishing points are calculated;
obtaining a second value by adding all of a number of the plurality of second batteries in the second list;
calculating a third value that is a smaller value among the first value and the second value;
generating a third list by extracting items from each of the first list and the second list according to a number of the third value; and
performing a one-to-one matching between the first batteries in the first list and the second batteries in the second list.

3. The apparatus of claim 2, wherein determining the battery replacement timings comprises:
determining each of the battery replacement timings that is a time point at which a robot corresponding to one item in the third list returns to the battery replacement station after completing a current work.

4. The apparatus of claim 2, wherein performing the battery replacement operation further comprises:
calculating a charging speed and a discharging speed of each of the plurality of first batteries and the plurality of second batteries based on the plurality of battery performance information pieces.

5. The apparatus of claim 4, wherein the charging speed defines a charge capacity per unit time of each of the plurality of first batteries, and
wherein generating the first list comprises:
based on at least one of the plurality of first batteries having a current SOC value greater than or equal to a second threshold value, determining the charge finishing points by adding a current time to a charging duration of each of the plurality of first batteries, wherein the charging duration is determined by dividing, by the charging speed of each of the plurality of first batteries, a difference between a current SOC value of each of the plurality of first batteries and a second threshold value; and
based on each of the charge finishing points of the plurality of first batteries being calculated, determining the first list by listing each of the plurality of first batteries in an order from an earliest charge finishing point among the charge finishing points.

6. The apparatus of claim 4, wherein generating the second list comprises:
determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station; and
based on the first value being greater than or equal to the second value, generating the second list by listing the plurality of second batteries in an ascending order from a lowest final SOC among the final SOCs of the plurality of second batteries.

7. The apparatus of claim 4, wherein generating the second list comprises:
determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station;
based on the first value being less than the second value, determining a remaining plurality of second batteries by excluding, in an ascending order from a lowest final SOC among the final SOCs of the plurality of second batteries, a number of second batteries among the plurality of second batteries corresponding to a difference between the first value and the second value; and
generating the second list by listing the remaining plurality of second batteries in the ascending order from the lowest final SOC.

8. The apparatus of claim 1, wherein the operations further comprise:
receiving a pending work list from a work database through the transceiver, the pending work list including work items;
determining whether at least one work item among the work items is performable before the battery replacement timing of a first robot among the plurality of robots; and
based on determining that the at least one work item is performable before the battery replacement timing, transmitting a command to the first robot through the transceiver to perform the at least one work item.

9. The apparatus of claim 1, wherein the operations further comprise:
based on transmitting the battery replacement command to the one or more first robots through the transceiver, generating a list of the one or more first robots in a descending order from a highest SOC at the battery replacement timings;
assigning a work item among a pending work list with a highest battery consumption amount to the one or more first robots in the descending order from the highest SOC; and
transmitting, through the transceiver, a command to the one or more first robots to perform the work item after a corresponding one of the battery replacement timings.

10. The apparatus of claim 1, wherein the operations further comprise:
transmitting a standby command to remaining one or more second robots excluding the one or more first robots from the plurality of robots through the transceiver;
determining whether an SOC of each of the one or more second robots is less than or equal to a threshold reference value;
determining one or more third robots having the SOC less than or equal to the threshold reference value among the one or more second robots;
transmitting, to the one or more third robots through the transceiver, a command to enter an energy-saving state after completing a current work of each of the one or more third robots; and
transmitting information regarding the one or more third robots to a user notification system through the transceiver.

11. A method for controlling replacement of robot batteries, the robot batteries including (i) a plurality of first batteries disposed at a battery replacement station for charging and (ii) a plurality of second batteries provided to a plurality of robots, the method being performed to determine a replacement schedule for the plurality of second batteries by using the plurality of first batteries charged at the battery replacement station, the method comprising:
receiving a state-of-charge (SOC) of each of the plurality of second batteries from each of the plurality of robots through a transceiver;
based on determining that one or more second batteries among the received SOCs of the plurality of second batteries are less than or equal to a predetermined first threshold value, initiating a battery replacement work;
receiving an SOC of each of the plurality of first batteries from the battery replacement station through the transceiver;
receiving a plurality of battery performance information pieces of the plurality of first batteries and the plurality of second batteries from a battery performance database through the transceiver;
generating each of a plurality of route information pieces, each of the plurality of route information pieces being configured to guide a corresponding one of the plurality of robots to reach the battery replacement station from a work location;
performing a battery replacement operation by using (i) the SOC of each of the plurality of first batteries, (ii) the SOC of each of the plurality of second batteries, (iii) the plurality of battery performance information pieces, and (iv) the plurality of route information pieces;
determining battery replacement timings of one or more first robots among the plurality of robots; and
transmitting a battery replacement command to at least one of the one or more first robots through the transceiver.

12. The method of claim 11, wherein performing the battery replacement operation comprises:
generating a first list representing a replacement priority of the battery replacement station based on (i) the SOC of each of the plurality of first batteries and (ii) the plurality of battery performance information pieces, the first list including the plurality of first batteries;
generating a second list representing replacement priorities of the plurality of robots based on (i) the SOC of each of the plurality of second batteries, (ii) the plurality of battery performance information pieces, and (iii) the plurality of route information pieces, the second list including the plurality of second batteries;
obtaining a first value by adding a number of batteries of the first batteries in the first list for which charge finishing points are calculated;
obtaining a second value by adding all of a number of the plurality of second batteries in the second list;
calculating a third value that is a smaller value among the first value and the second value;
generating a third list by extracting items from each of the first list and the second list according to a number of the third value; and
performing a one-to-one matching between the first batteries in the first list and the second batteries in the second list.

13. The method of claim 12, wherein determining the battery replacement timings comprises:
determining each of the battery replacement timings that is a time point at which a robot corresponding to one item in the third list returns to the battery replacement station after completing a current work.

14. The method of claim 12, wherein performing the battery replacement operation further comprises:
calculating a charging speed and a discharging speed of each of the plurality of first batteries and the plurality of second batteries based on the plurality of battery performance information pieces.

15. The method of claim 14, wherein the charging speed defines a charge capacity per unit time of each of the plurality of first batteries, and
wherein generating the first list comprises:
based on at least one of the plurality of first batteries having a current SOC value greater than or equal to a second threshold value, determining the charge finishing points by adding a current time to a charging duration of each of the plurality of first batteries, wherein the charging duration is determined by dividing, by the charging speed of each of the plurality of first batteries, a difference between a current SOC value of each of the plurality of first batteries and a second threshold value; and
based on each of the charge finishing points of the plurality of first batteries being calculated, determining the first list by listing each of the plurality of first batteries in an order from an earliest charge finishing point among the charge finishing points.

16. The method of claim 14, wherein generating the second list comprises:
determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station; and
based on the first value being greater than or equal to the second value, generating the second list by listing the plurality of second batteries in an ascending order from a lowest final SOC among the final SOCs of the plurality of second batteries.

17. The method of claim 14, wherein generating the second list comprises:
determining a final SOC of each of the plurality of second batteries by subtracting, from a current SOC of each of the plurality of second batteries, (i) a battery consumption amount for performing a work assigned to each of the plurality of robots and (ii) a battery consumption amount for each of the plurality of robots to return to the battery replacement station;
based on the first value being less than the second value, determining a remaining plurality of second batteries by excluding, in an ascending order from a lowest final SOC among the final SOCs of the plurality of second batteries, a number of second batteries among the plurality of second batteries corresponding to a difference between the first value and the second value; and
generating the second list by listing the remaining plurality of second batteries in the ascending order from the lower final SOC.

18. The method of claim 11, further comprising:
receiving a pending work list from a work database through the transceiver, the pending work list including work items;
determining whether at least one work item among the work items is performable before the battery replacement timing of a first robot among the plurality of robots; and
based on determining that the at least one work item is performable before the battery replacement timing, transmitting a command to the first robot through the transceiver to perform the at least one work item.

19. The method of claim 11, further comprising:
based on transmitting the battery replacement command to the one or more first robots through the transceiver, generating a list of the one or more first robots in a descending order from a highest SOC at the battery replacement timings;
assigning a work item among a pending work list with a highest battery consumption amount to the one or more first robots in the descending order from the highest SOC; and
transmitting, through the transceiver, a command to the one or more first robots to perform the work item after a corresponding one of the battery replacement timings.

20. The method of claim 11, further comprising:
transmitting a standby command to remaining one or more second robots excluding the one or more first robots from the plurality of robots through the transceiver;
determining whether an SOC of each of the one or more second robots is less than or equal to a threshold reference value;
determining one or more third robots having the SOC less than or equal to the threshold reference value among the one or more second robots;
transmitting, to the one or more third robots through the transceiver, a command to enter an energy-saving state after completing a current work of each of the one or more third robots; and
transmitting information regarding the one or more third robots to a user notification system through the transceiver.
